(19) United States
(12) Patent Application Publication
(10) Pub. No.: US 2007/0058106 A1
(43) Pub. Date: Mar. 15, 2007

(54) Surface light source apparatus

(75) Inventors: Hyoung-Joo Kim, Gyeonggi-do (KR); Jin-Seob Byun, Seoul (KR); Dong-Woo Kim, Gyeonggi-do (KR); Nam-Hun Kim, Seoul (KR); Sang-Yu Lee, Gyeonggi-do (KR)

Correspondence Address: CANTOR COLBURN, LLP, 55 GRIFFIN ROAD SOUTH, BLOOMFIELD, CT, 06002, US

(73) Assignees: SAMSUNG ELECTRONICS CO., LTD., Gyeonggi-do (KR); SAMSUNG CORNING CO., LTD., Gyeeonggi-do (KR)

(21) Appl. No.: 10/576,053

(22) PCT Filed: Oct. 21, 2004
(86) PCT No.: PCT/KR04/02691

§ 371 Date: Apr. 18, 2006

(30) Foreign Application Priority Data
Oct. 25, 2003 (KR) 10-2003-0074872

(51) Int. Cl. G02F 1/1335

(52) U.S. Cl. 349/71

(57) ABSTRACT

A surface light source apparatus (100) includes a main body (105) having a space, and a plurality of space division members (130) being disposed in the space so that the space division members (130) are extended in a first direction and arranged in a second direction spaced apart from one another to divide the space into a plurality of light emitting spaces (112). The space division members (130) include a plurality of connecting holes (132). At least two of the connecting holes (132) have different heights from one another with respect to a bottom surface of the main body (105) to have the light emitting spaces connected to one another through the connecting holes (132). The surface light source apparatus also includes a visible light emitting unit to generate a visible light in the light emitting spaces. Therefore, the brightness-uniformity of the surface light source apparatus and an image display quality of a display device are improved.

### TECHNICAL FIELD

The present invention relates to a surface light source apparatus and a display device having the surface light source apparatus. More particularly, the present invention relates to the surface light source apparatus capable of improving a brightness and a brightness-uniformity, and a display device having the surface light source apparatus.

### BACKGROUND ART

In general, display devices convert data processed in information processing devices into images. A liquid crystal display (hereinafter, referred to as LCD) device is one of the display devices, and displays the image using a liquid crystal (hereinafter, referred to as LC).

The LC has electric and optical characteristics. The LC varies an arrangement corresponding to a direction of an electric field applied thereto so that the LC varies a light transmittance corresponding to the arrangement of the LC.

The LCD device displays the image using the electric and optical characteristics.

The LCD device is smaller and lighter than a cathode ray tube (CRT). Therefore, the LCD device is widely used in various electric apparatuses such as a mobile computer, a communication device, a liquid crystal TV, an airplane, etc.

The LCD device includes an LC controlling part controlling the LC and a light supplying part supplying the liquid crystal with a light.

The LC controlling part includes a pixel electrode disposed on a first substrate, a common electrode disposed on a second substrate and the LC disposed between the first and second substrates. The first substrate includes a plurality of pixel electrodes formed thereon. A number of the pixel electrodes correspond to a resolution of the LCD device. The second substrate includes one common electrode corresponding to the pixel electrodes.

Each of the pixel electrodes is connected to a thin film transistor to receive a pixel voltage, and an equal level of reference voltage is applied to the common electrode. The pixel electrode and the common electrode of the LCD device include a transparent conductive material.

A light supplying part supplies the LC in the liquid crystal controlling part with the light. The light passes through the pixel electrode, the LC and the common electrode, so that the LC controlling part displays the image. When a brightness-uniformity of the light supplying part is increased, an image display quality of the LCD device is improved.

The light supplying part, in general, may include a cold cathode fluorescent lamp (CCFL) or a light emitting diode (LED). The CCFL has various characteristics such as a high brightness and a long endurance. The CCFL generates a white light, and the CCFL generates a small amount of heat when compared with a heat generated from an incandescent lamp. The LED also has various characteristics such as a low power consumption and a high brightness.

However, a brightness of the light generated from the CCFL or the LED is not uniform.

Therefore, the light supplying part includes optical members such as a light guide panel, a diffusion sheet and a prism sheet to improve the brightness uniformity.

However, when the light supplying part includes the optical members, size and weight of the display device are increased.

### DISCLOSURE OF INVENTION

Technical Problem

The present invention provides a surface light source apparatus capable of improving a brightness and a uniformity of the brightness.

The present invention also provides a display device having the above surface light source apparatus.

### TECHNICAL SOLUTION

A surface light source apparatus in accordance with an aspect of the present invention includes a main body having a space, a plurality of space division members and a visible light emitting unit. The space division members are disposed in the space so that the space division members are extended in a first direction and arranged in a second direction. The space division members are spaced apart from one another to divide the space into a plurality of light emitting spaces. The space division members include a plurality of connecting holes. At least two of the connecting holes have different heights from one another with respect to a bottom surface of the main body. The light emitting spaces are connected to one another through the connecting holes. The visible light emitting unit generates a visible light in the light emitting space.

A display device in accordance with an aspect of the present invention includes a surface light source apparatus and a display panel. The surface light source apparatus includes a main body, a plurality of space division members and a visible light emitting unit. The main body has a space formed by a first substrate, a second substrate facing the first substrate and a sealant disposed between the first and second substrates. The space division members are disposed in the space. The space division members are extended in a first direction and arranged in a second direction. The space division members are spaced apart from one another to divide the space into a plurality of light emitting spaces. The space division members include a plurality of connecting holes. At least two of the connecting holes have different heights from one another with respect to a bottom surface of the main body. The light emitting spaces are connected to one another thrash the connecting holes. The visible light emitting unit generates a visible light in the light emitting space. The display panel converts the visible light into an image light having information.

According to the present invention, the space division members include the connecting hole having different heights from one another to prevent a channeling that may be formed by a movement of plasma between the light emitting spaces. Therefore, a brightness of the surface light source is uniformized to improve an image display quality of a display apparatus.

### BRIEF DESCRIPTION OF THE DRAWINGS

The above objects and other advantages of the present invention will become more apparent by describing in detail the preferred embodiments thereof with reference to the accompanying drawings, in which:

FIG. 1 is a partially cut out perspective view showing a surface light source apparatus according to an exemplary embodiment of the present invention;

FIG. 2 is a plan view showing a first substrate shown in FIG. 1;

FIG. 3 is a cross-sectional view taken along a line I-I shown in FIG. 1;

FIG. 4 is an enlarged perspective view showing a portion ‘C’ shown in FIG. 1;

FIG. 5 is an enlarged perspective view showing a portion ‘D’ shown in FIG. 1;

FIG. 6 is an enlarged perspective view showing a portion ‘E’ shown in FIG. 1;

FIG. 7 is a cross-sectional view taken along a line II-II′ shown in FIG. 1;

FIG. 8 is an enlarged perspective view showing a portion ‘F’ shown in FIG. 1;

FIG. 9 is a cross-sectional view showing a surface light source apparatus according to another exemplary embodiment of the present invention;

FIG. 10 is a cross-sectional view showing a surface light source according to another exemplary embodiment of the present invention; and

FIG. 11 is a partially cat out perspective view showing a display device according to another exemplary embodiment of the present invention.

### BEST MODE FOR CARRYING OUT THE INVENTION

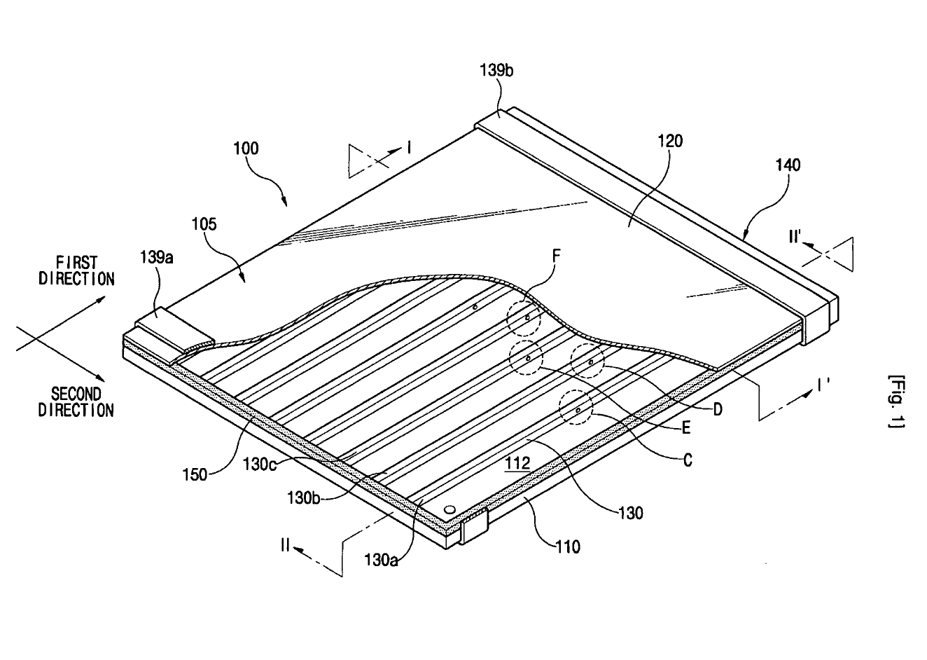

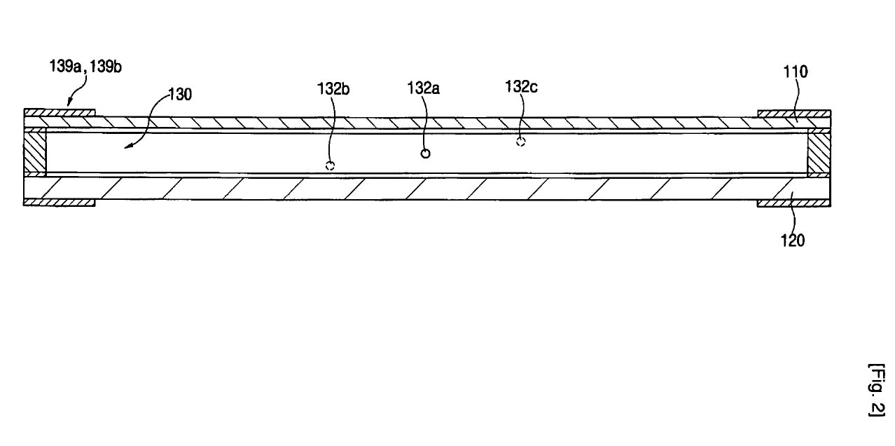

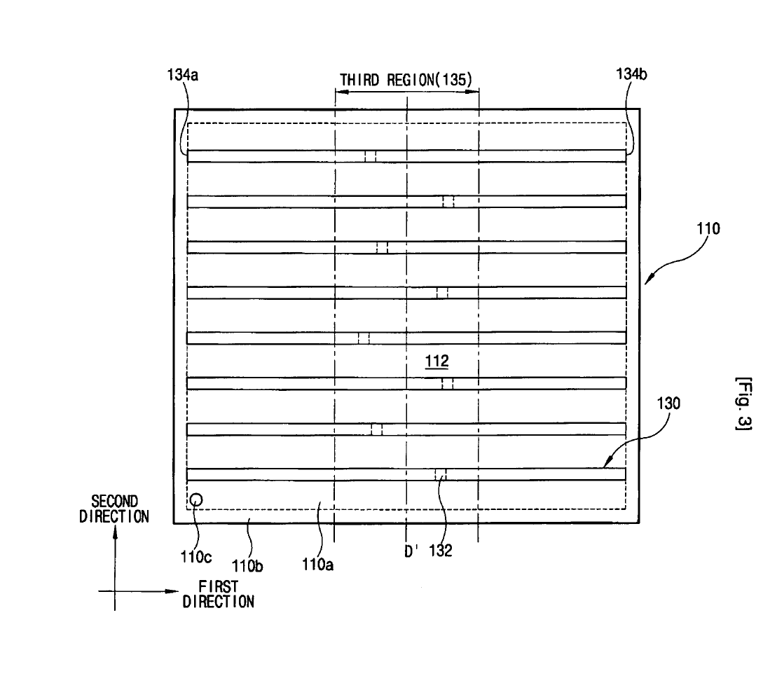

FIG. 1 is a partially cut act perspective view showing a surface light source apparatus according to an exemplary embodiment of the present invention. FIG. 2 is a plan view showing a first substrate shown in FIG. 1. FIG. 3 is a cross-sectional view taken along a line I-I′ shown in FIG. 1.

Referring to FIGS. 1 to 3, a surface light source apparatus 100 includes a main body 105, a space division member 130 and a visible light generating unit 140. In the present exemplary embodiment, the surface light source apparatus 100 may include a plurality of the space division members 130.

The main body 105 has a space therein. In the present exemplary embodiment, the main body 105 includes a first substrate 110a second substrate 120 and a sealant 150.

The first substrate 110 is an ultraviolet light-absorbing substrate that absorbs an ultraviolet light, and a visible light may pass through the first substrate 110. The first substrate 110 includes a first region 110a and a first peripheral region 110b. The first region 110a is surrounded by the first peripheral region 110b.

Referring to FIG. 3, the second substrate 120 is opposite to the first substrate 110. The second substrate 120 is the ultraviolet light-absorbing substrate that absorbs the ultraviolet light, and the visible light may pass through the second substrate 120. The second substrate 120 includes a second region 120a and a second peripheral region 120b. The second region 120a is surrounded by the second peripheral region 120b.

In the present exemplary embodiment, the second region 120a corresponds to the first region 110a, and the second peripheral region 120a corresponds to the first peripheral region 110b.

The sealant 150 is disposed between the first peripheral region 110b of the first substrate 110 and the second peripheral region 120b of the second substrate 120. The sealant 150 having a rectangular shape has a substantially identical shape and width to the first and second peripheral regions 110b and 120b.

The first adhesive 150a is disposed between the sealant 150 and the first peripheral region 110b, and the second adhesive 150b is disposed between the sealant 150 and the second peripheral region 120b. The first and second substrates 110 and 120 are combined with the sealant 150 by the first adhesive 150a and the second adhesive 150b, respectively.

Therefore, the first substrate 110 the second substrate 120 and the sealant 150 form the space.

In the present embodiment, the sealant has a substantially identical thermal expansion coefficient to the first and second substrates 110 and 120.

The main body 105 includes the space division members 130 dividing the space formed by the first substrate 110 the second substrate 120 and the sealant 150 into a plurality of light emitting spaces so that an amount of energy for generating the light in the light emitting spaces is decreased.

Referring to FIGS. 2 and 3, the space division members 130 are disposed between the first substrate 110 and the second substrate 120 and the space division members 130 are disposed between the first region 110a and the second region 110b. The space division members 130 are extended to the first direction and a plurality of the space division members 130 are disposed along the second direction that is substantially perpendicular to the first direction. The space division members 130 having a wall shape include a transparent thermosetting material or an opaque thermosetting material.

The space of the main body 105 is divided into the light emitting spaces by the space division members 130. When the space of the main body 105 is divided into the space division members 130, levels of driving voltage and power consumption of the surface light source apparatus are decreased.

In the present exemplary embodiment, a first end portion 134a and a second end portion 134b make contact with the sealant 150. The light emitting spaces 112 are spaced apart from one another by the space division members 130.

When the space of the main body 105 is divided into the light emitting spaces 112, pressures of discharge gases (or a mixed gas) in the light emitting spaces may be different from one another. When the pressures of the discharge gas in the light emitting spaces 112 are different from one another, amounts of lights generated in the light emitting spaces 112 may be different from one another.

A connecting hole 132 is formed in each of the space division members 130 to supply the light emitting spaces 112 with the discharge gas. The light emitting spaces 112 are connected to one another through the connecting hole 132. T discharge gas in one of the light emitting spaces 112 is diffused into the whole light emitting spaces, so that the pressures of the discharge gas in the light emitting spaces 112 are substantially equal to one another. In the present exemplary embodiment, the connecting hole 132 is formed in each of the space division members 130 and the connecting hole 132 has a circular cross section. A diameter of the connecting hole 132 is about 0.1 mm to about 0.5 mm. Alternatively, the connecting hole 132 may have a polygonal cross section such as a triangular cross section, a quadrangular cross section and so on.

Referring now to FIG. 2, the connecting hole 132 formed in each of the space division members 130 is disposed on left and right portions of the bottom surface of the space of a third region 135. The third region 135 is divided by a line D′ that bisects each of the space division members 130 by a predetermined distance. In the present exemplary embodiment, the third region 135 is disposed on a region adjacent to the line D′ that bisects each of the space division members 130. A length of each of the left and right portions is about 2.5 cm to about 3 cm. A total length of the third region 135 is about 5 cm to about 6 cm.

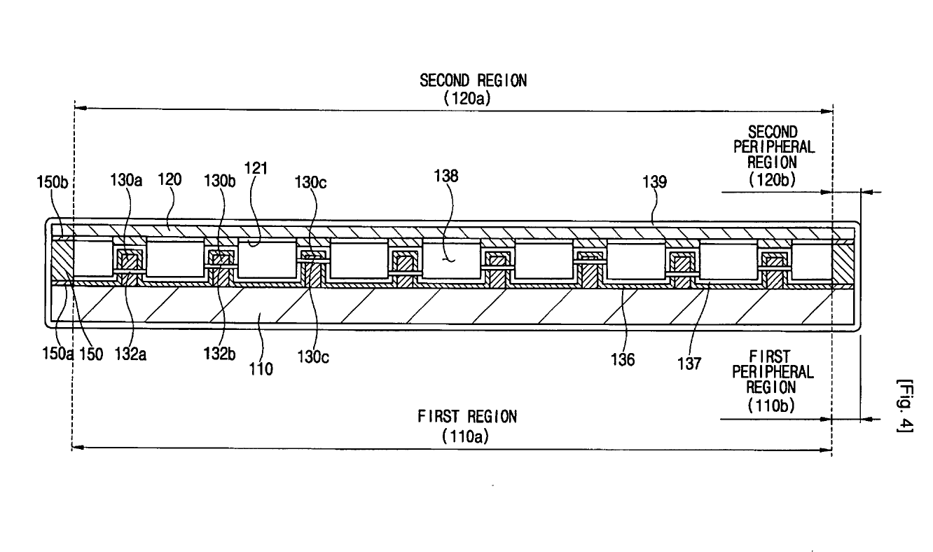

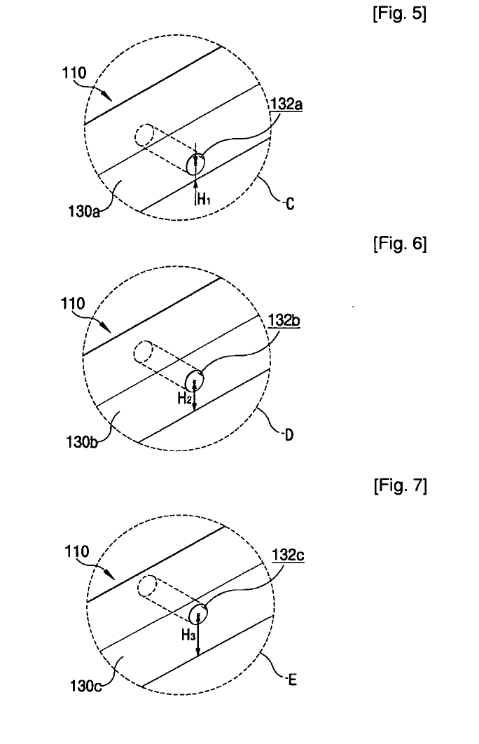

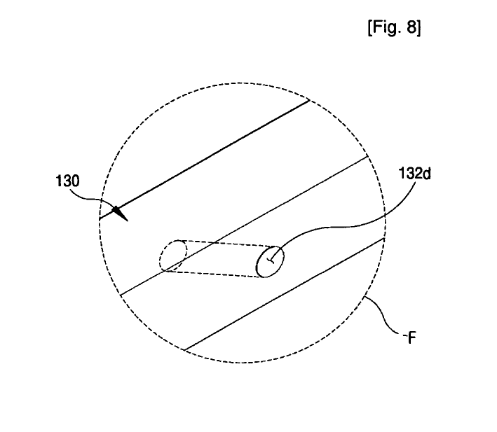

FIG. 4 is an enlarged perspective view showing a portion ‘C’ shown in FIG. 1. FIG. 5 is an enlarged perspective view showing a portion ‘D’ shown in FIG. 1. FIG. 6 is an enlarged perspective view showing a portion ‘E’ shown in FIG. 1. FIG. 7 is a cross-sectional view taken along a line II-II′ shown in FIG. 1.

Referring to FIGS. 4 to 6, the heights between the bottom surface of the space of the main body 105 and the center of the connecting holes 132 formed in the space division members 130 are different from one another. For example, a first height between the center of an n-th connecting hole 132a in an n-th space division member (130a) and the bottom surface of the space of the main body 105 is represented by a reference numeral H1. The n is a natural number. A second height between the center of an (n+1)-th connecting hole 132b in an (n+1)-th space division member 130b and the bottom surface of the space of the main body 105 is represented by a reference numeral H2. A third height between the center of an (n+2)-th connection hole 132c in an (n+2)-th space division member 130c and the bottom surface of the space of the main body 105 is represented by a reference numeral H3.

Referring to FIG. 7, the first, second and third heights H1, H2 and H3 of connecting holes with respect to a bottom surface of a main body 105 are different from one another (H1≠H2≠H3). When the connecting holes have different heights from one another, a channeling frequency formed in a space adjacent to the connecting holes is decreased.

An n-th space division member 130a, an (n+1)-th space division member 130b and an (n+2)-th space division member 130c may be alternately disposed on a bottom surface of the main body 105.

Alternatively, the n-th space division member 130a, the (n+1)-th space division member 130b and the (n+2)-th space division member 130c may be randomly disposed on the bottom surface of the main body 105. The heights of the connecting holes disposed adjacent to each other are different from one another.

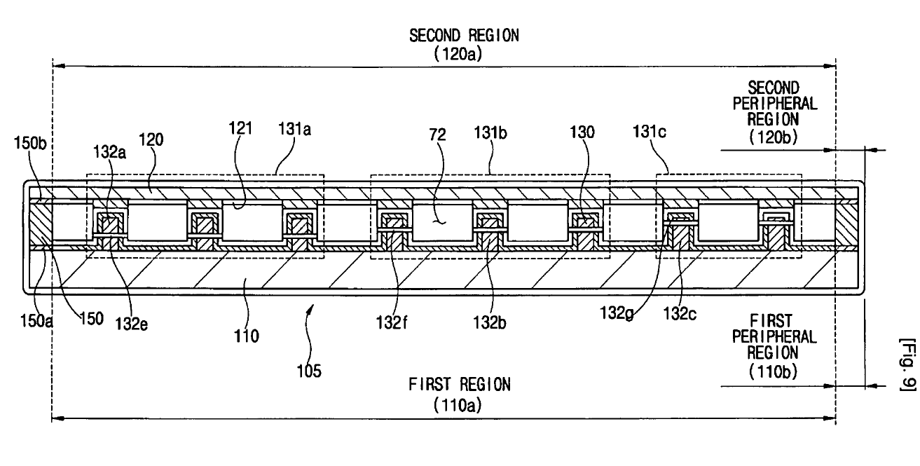

FIG. 8 is an enlarged perspective view showing a portion ‘F’ shown in FIG. 1.

Referring to FIG. 8, a connecting hole formed on each of space division members 130 may be formed in an inclined direction with respect to surfaces of the space division members 130. When the connecting hole formed on each of the space division members 130 is formed in the inclined direction, a channeling frequency in each of the space division members 130 may be decreased.

Referring to FIGS. 1 and 2, the visible light unit 140 includes a first fluorescence layer 137a, a second fluorescence layer 137b, a discharge gas 138 and an electric source applying part 139.

The first fluorescence layer 137a and the second fluorescence layer 137b convert an invisible light generated from the discharge gas 138 into the visible light. The discharge gas is introduced into each of the light emitting spaces 112 formed by the space division members 130. That is, the discharge gas 138 is introduced into each of the light emitting spaces 112 thrash a penetration hole 110c formed by the first substrate 110 and the connecting hole 132 formed by the space division members 130.

In the present exemplary embodiment, the discharge gas includes mercury (Hg) and neon (Ne). The discharge gas may further comprise argon (Ar), krypton (Kr), xenon (Xe) so as to generate a penning effect. The penning effect decreases a discharge voltage of the discharge gas.

Light reflection layers 136 may be additionally disposed on in the first region 110a of the first substrate 110 on which the space division members 130 are formed. The light reflection layer 136 is disposed on the first substrate 110q and disposed between the surfaces of the space division members 130. The light reflection layer 136 may include a titanium oxide thin film (TiO thin film) or an aluminum oxide thin film (Al₂O₃ thin film). The light reflection layer 136 may be formed by deposition metal on the first substrate 110 or spraying a liquid metal on the first substrate 110. The visible light generated from the discharge gas is reflected from the light reflection layer 136 of the first substrate 110 toward the second substrate 120 to improve brightness.

The electric source applying part 139 includes a first electrode 139a and a second electrode 139b so as to generate a discharge in each of the light emitting spaces 112. When the discharge voltage that has a voltage difference sufficient to generate the discharge are applied to the light emitting space 112.

The first electrode 139a and the second electrode 139b are disposed on cater surface of the first substrate 110 and the second substrate 120. Alternatively, the first electrode 139a or the second electrode 139b may be disposed in the light emitting spaces 112. The first and second electrodes 139a and 138b may also be disposed in the light emitting spaces 112.

The connecting holes have different heights from one another to prevent a channeling of the surface light source apparatus so that the brightness of the surface light source apparatus is uniformized.

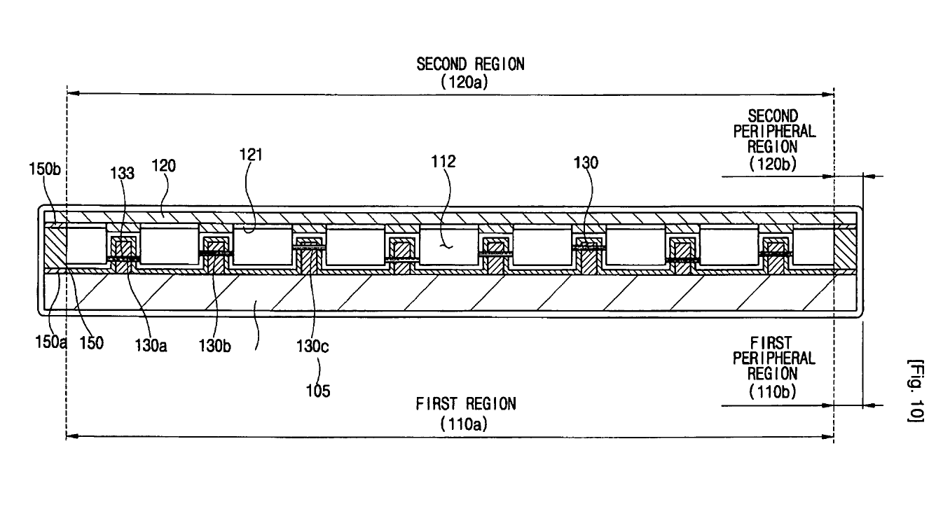

FIG. 9 is a cross-sectional view showing a surface light source apparatus according to another exemplary embodiment of the present invention. The surface light source apparatus according to the present exemplary embodiment is same as in the first exemplary embodiment except for a connecting hole formed on a space division member. Thus, any further explanation for the same elements will be omitted.

Referring to FIG. 9, space division members 130 in a surface light source apparatus 100 are divided into a plurality of groups. The surface light source apparatus 100 may be divided into three groups. In the present exemplary embodiment, the three groups include a first group 131a, a second group 131b and a third group 131c.

An n-th space division member 132a is disposed in the first group 131a. An (n+1)-th space division member 132b is disposed in the second group 131b. An (n+2)-th space division member 132c is disposed in the third group 131c.

A first connecting hole 132e formed on the n-th space division member 132a has a first height H1 with respect to a bottom surface of a space of a main body 105. A second connecting hole 132f formed on the (n+1)-th space division member 132b has a second height H12. A third connecting hole 132g formed on the (n+2)-th space division member 132c has a third height H3. The first connecting hole 132e, the second connecting hole 132f and the third connecting hole 132g have different heights from one another, so that the channeling frequency is lowered.

Channeling of the surface light source apparatus is prevented by the connecting holes having different heights from one another so that the brightness of the surface light source apparatus is uniformized.

FIG. 10 is a cross-sectional view showing a surface light source apparatus according to another exemplary embodiment of the present invention. A surface light source apparatus according to the present exemplary embodiment is same as in the surface light source apparatus according to the first exemplary embodiment except a discharge gas supplying member disposed on a connection hole that is formed on a space division member. Thus, any further explanation for the same elements will be omitted.

Referring to FIG. 10, discharge gas supplying member 133 is disposed in each of connecting holes 130a, 130b and 130c of each of space division members 130. The connecting holes 130a, 130b and 130c have different heights from one another. The discharge gas supplying member 133 may include mercury big), porous alloy having gases, etc. A discharge gas is introduced into the light emitting spaces 112 through the connecting holes 130a, 130b and 130c so that the discharge gas supplying member 133 supplies both of the light emitting spaces 112 with the discharge gas. The discharge gas supplying member 133 may include an impurity gas adsorbing member so as to adsorb oxygen, carbon dioxide, nitrogen, hydrogen and water, which are disposed in the light emitting spaces 112.

The discharge gas in discharge gas supplying members 133 is heated so that the discharge gas is supplied to the light emitting spaces 112, and the impurity gases disposed in light emitting space 112 are adsorbed and removed by the impurity gas adsorbing member. That is, substantially pure discharge gas is supplied to light emitting space 112.

The discharge gas supplying member 133 includes fine porous holes, so that the discharge gas except a plasma may be passed freely through the porous holes so as to prevent a non-uniformity of the brightness due to a rapid movement of plasma

The discharge gas supplying member 133 continuously supply the discharge gas, so that an endurance of the surface light source apparatus may be increased.

The discharge gas may be dispersed to adjacent light emitting space 112 thrash the discharge gas supplying member 133 and the impurity gas adsorbing member in the connecting hole. However, movement of the plasma is decreased by the discharge gas supplying member, so that the brightness-uniformity and the endurance of the surface light source may be increased.

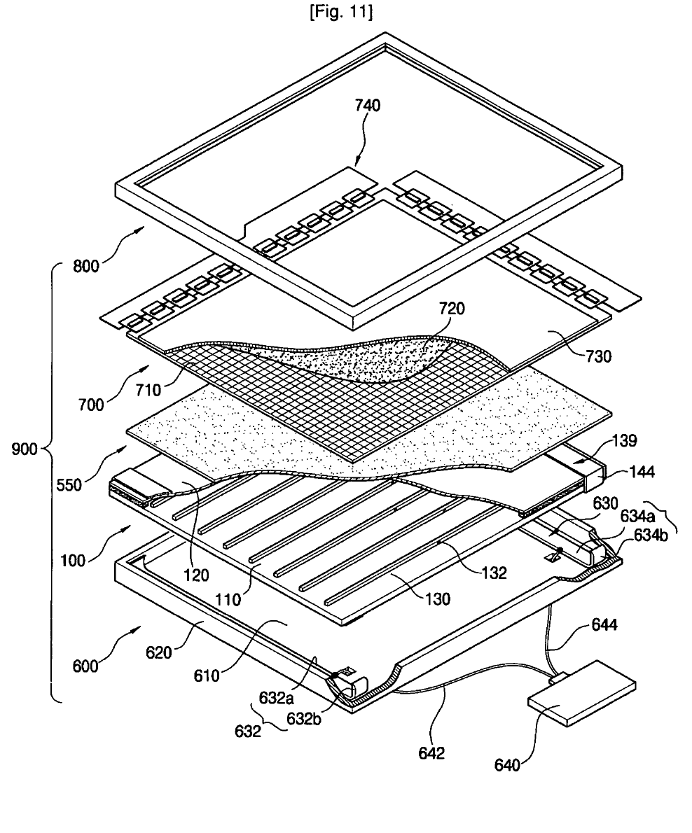

FIG. 11 is a partially cut out perspective view showing the display device according to another exemplary embodiment of the present invention. The surface light source apparatus according to the present exemplary embodiment is same as in the third embodiment described above. Thus, any further explanation for the same elements will be omitted.

Referring to FIG. 11, a liquid crystal display device 900 includes a receiving container 60) a surface light source apparatus 100, a liquid crystal display panel 700 and a chassis 800.

The receiving container 600 includes a plurality of side walls 620 protruded from sides of a base plate 610 to form a receiving space, a discharge voltage applying module 630 and an inverter 640. The receiving container 600 is fixed to prevent drifting of the surface light source apparatus 100 or the liquid crystal display panel 700.

The surface light source apparatus 100 is disposed on the base plate 610. The base plate 610 has a substantially identical shape to the surface light source apparatus 100. In the present exemplary embodiment, the base plate 610 has a rectangular parallelepiped shape, and the surface light source apparatus 100 has a shape that is substantially equal to the base plate 610.

The side wall 620 is protruded from sides of the base plate 610 to prevent a drifting of the surface light source apparatus 100.

A discharge voltage applying module 630 applies a discharge voltage to an electric source applying part 139 of the surface light source apparatus 100. The discharge voltage applying module 630 includes a first discharge voltage applying module 632 and a second discharge voltage applying module 634. The first discharge voltage applying module 632 includes a first conductive main body 632a and a first conductive clip 632b formed on the first conductive main body 632a. The second discharge voltage applying module 634 includes a second conductive main body 634a and a second conductive clip 634b formed on the second conductive main body 634b.

The electric source applying part 139 formed on the surface light source apparatus 100 is griped and fixed on the first conductive clip 632b and the second conductive clip 634b.

The inverter 640 applies the discharge voltage to the first discharge applying module 632 and the second discharge applying module 634. The inverter 640 is electrically connected to the first discharge voltage applying module 632 through the first electric source applying line 642. The inverter 640 is electrically connected to the second discharge voltage applying module 634 through the second electric source applying line 644.

The surface light source apparatus 100 includes a first substrate 110, a second substrate 120, a space division member 130 and an electric source applying part 140. In this exemplary embodiment, the surface light source apparatus 100 includes a plurality of the space division members 130. The space division members 130 are disposed on the first substrate 110. The connecting hole is formed in each of the space division members 130 so that the discharge gas is introduced into the light emitting spaces through the connecting holes 132. Distances between each of the connecting holes 132 and each of the ends of the space division members 130 are different from one another. Amounts of the discharge gas introduced into each of the spaced division members 130 are substantially equal to one another by the connecting holes 132.

The liquid crystal display panel 700 converts a light generated in surface light source apparatus 100 into an image light having information. The liquid crystal display panel 700 includes a TFT substrate 710, a liquid crystal 72q a color filter substrate 730 and a driving module 740.

The TFT substrate 710 includes a pixel electrode arranged in a matrix shape, a thin film transistor applying a driving voltage to each of the pixel electrodes, a gate line and a data line. The color filter substrate 730 includes a color filter disposed corresponding to the pixel electrode, and a common electrode formed on the color filter.

The liquid crystal 720 is disposed between the TFT substrate 710 and the color filter substrate 730. Sides of the color filter substrate 730 of the liquid crystal display panel 700 are surrounded by the chassis 800, and a portion of the chassis 800 is hooked to the receiving container 600. The chassis 800 protects the liquid crystal display panel 700 from an impact that is provided from an exterior to the liquid crystal display panel 70Q and prevents a drifting of the liquid crystal display panel 700 in receiving container 600. A light diffusion member that diffuses the light generated from the surface light source apparatus 100 is represented by a reference numeral 550.

Experimental Example

In the present experimental example, a surface light source apparatus of the present experimental example is the same as shown in FIGS. 1 to 3. The same reference numerals will be used to refer to the same or like parts as those described in FIGS. 1 to 3 and any further explanation will be omitted.

TABLE 1

| | | | Channeling |
|---|---|---|---|
| | | | frequency (No. of |
| | | Output | Channeling/Total |
| | Applied voltage | current | No. of experiments) |
| N-th space | 120[v] | 134[mA] | 3/30 |
| division member | | | |
| (H1) | | | |
| (n + 1)-th space | 120[v] | 132[mA] | 7/30 |
| division member | | | |
| (H2) | | | |
| (n + 2)-th space | 120[v] | 125[mA] | 10/30 |
| division member | | | |
| (H3) | | | |
| Control group | 120[v] | — | 28/30 |

Table 1 represents experimental data of channeling frequencies according to positions of connecting holes of the n-th space division member 130a having a first height H1 with respect to a bottom surface of the space of a main body 105, the (n+1)-th space division member 130b having a second height of H2 with respect to the bottom surface of the space of the main body 105, and the (n+2)-th space division member 130c having a third height of H3 with respect to the bottom surface of the space of the main body 105.

The control group is a conventional surface light source apparatus having a serpentine structure that does not have a connecting hole. When plasma is concentrated in one of light emitting spaces, uniformity of a brightness of the surface light source apparatus is deteriorated. “Channeling frequency” is the frequency of brightness non-uniformity. An output current is an amount of a current flowing thrash each of the light emitting spaces. When the output current is increased, the amount of the light generated in the light emitting space is increased.

Referring to Table 1, when the total number of the experiments was thirty, the number of the channeling generated in the conventional surface light source apparatus was twenty eight. When the total number of the experiments was thirty, the number of the channeling generated in the n-th space division member 130a having the first height of H1 with respect to the bottom surface of the space of the main body 105 was three. When the total number of the experiments was thirty, the number of the channeling generated in the (n+1)-th space division member 130a having the second height of H2 with respect to the bottom surface of the space of main body 105 was seven. When the total number of the experiments was thirty, the number of the channeling generated in the (n+2)-th space division member 130a having the third height of H3 with respect to the bottom surface of the space of main body 105 was ten. The first height H1 was lower than the second height H2, and the second height H2 was lower than the third height H3 (H1<H2<H3).

Furthermore, amounts of output currents flowing thrash the light emitting spaces formed by the n-th space division member 130a, the (n+1)-th space division member 130b and the (n+2)-th space division member 130a were substantially equal to one another. Deviations of the output currents flowing through the light emitting spaces formed by the n-th space division member 130a, the (n+1)-th division member 130b and the (n+2)-th division member 130c were smaller than deviations of the output currents of the control group. Thus, the brightness of portions of the light generated in the light emitting spaces formed by the n-th space division member 130a, the (n+1)-th space division member 130b and the (n+2)-th space division member 130c were sub-substantially equal to one another.

According to the present experimental example, the connecting holes of the space division members had the heights that were different from one another so that the brightness of the surface of the surface light source apparatus was uniformized.

### INDUSTRIAL APPLICABILITY

As described in detail above, the space division members include the connecting hole having different heights from one another so as to prevent a channeling effect that may be generated by a movement of plasma between the light emitting spaces. Therefore, a brightness of the surface light source is uniformized to improve an image display quality of a display apparatus.

The present invention has been described above with reference to the aforementioned embodiments. It is evident, however, that many alternative modifications and variations will be apparent to those having skills in the art in light of the foregoing description. Accordingly, the present invention embraces all such alternative modifications and variations as fall within the spirit and scope of the appended claims.

1. A surface light scarce apparatus comprising:
a main body having a space;
a plurality of space division members disposed in the space so that the space division members are extended in a first direction and arranged in a second direction, the space division members being spaced apart from one another to divide the space into a plurality of light emitting spaces, the space division members including a plurality of connecting holes, at least two of the connecting holes having different heights from one another with respect to a bottom surface of the main body, and the light emitting spaces being connected to one another thrash the connecting holes; and
a visible light emitting unit to generate a visible light in the light emitting spaces.

2. The surface light source apparatus of claim 1, wherein end portions of the space division members make contact with an inner surface of the main body.

3. The surface light source apparatus of claim 1, wherein each of the space division members corresponds to each of the connecting holes.

4. The surface light source apparatus of claim 3, wherein the surface light source apparatus comprises a plurality of space division member groups that are sub-substantially equal to one another, each of the space division member groups includes three space division members disposed adjacent to one another, and three connecting holes of the three space division members have different heights from one another.

5. The surface light source apparatus of claim 3, wherein the connecting holes are spaced apart from a side surface of the main body by different distances from one another.

6. The surface light source apparatus of claim 1, wherein the space division members are divided into a plurality of groups, and the heights of the connecting holes of the space division members of each of the groups are substantially equal to one another.

7. The surface light source apparatus of claim 1, wherein each of the connecting holes is slant toward the first direction.

8. The surface light source apparatus of claim 1, wherein the main body comprises a first substrate, a second substrate corresponding to the first substrate, and a sealant disposed between the first and second substrates to form the space between the first and second substrates.

9. The surface light source apparatus of claim 1, wherein the visible light emitting unit comprises:
a discharge gas disposed in the light emitting spaces to generate a non-visible light;
a fluorescence layer formed on an inner surface of the main body to convert the non-visible light into the visible light; and
an electric source applying part to generate a discharge in the light emitting spaces so as to generate the non-visible light.

10. The surface light source apparatus of claim 9, further comprising a light reflection layer disposed between a portion of the main body and the flu orescence layer so that the visible light is reflected from the light reflection layer toward the light emitting space.

11. The surface light source apparatus of claim 10, wherein the electric source applying part comprises a first electrode formed on a surface of the main body and a second electrode spaced apart from the first electrode.

12. The surface light source apparatus of claim 1, wherein each of the space division member further comprises a discharge gas supplying member disposed in each of the connecting holes so that the discharge gas is introduced into each of the light emitting spaces through the discharge gas supplying member.

13. The surface light source apparatus of claim 12, wherein the discharge gas supplying member further comprises an impurity gas absorbing member to absorb an impurity gas in each of the light emitting spaces to collect the impurity gas.

14. A display device comprising:
a surface light source apparatus including:
a main body having a space formed by a first substrate, a second substrate facing the first substrate and a sealant disposed between the first and second substrates;
a plurality of space division members disposed in the space so that the space division members are extended in a first direction and arranged in a second direction, the space division members being spaced apart from one another to divide the space into a plurality of light emitting spaces, the space division members including a plurality of connecting holes, at least two of the connecting holes having different heights from one another with respect to a bottom surface of the main body, and the light emitting spaces being connected to one another thrash the connecting holes; and
a visible light emitting unit to generate a visible light in the light emitting spaces; and
a display panel converting the visible light into an image light having information.

15. The display device of claim 14, wherein end portions of the space division members make contact with an inner surface of the main body.

16. The display device of claim 14, wherein each of the connecting holes of the surface light source apparatus is slant toward the first direction.

17. The display device of claim 14, wherein each of the space division members further comprises a discharge gas supplying member disposed in each of the connecting holes so that the discharge gas is introduced into each of the light emitting spaces through the discharge gas supplying member.

18. The display device of claim 14, wherein the discharge gas supplying member of the surface light source apparatus further comprises an impurity gas absorbing member to absorb an impurity gas in each of the light emitting spaces to collect the impurity gas.
